(19) United States
(12) Patent Application Publication
(10) Pub. No.: US 2009/0290859 A1
(43) Pub. Date: Nov. 26, 2009

(54) Image pickup device and method of correcting camera shake of the image pickup device

(75) Inventor: Takashi Soga, Saitama (JP)

Correspondence Address: TAIYO CORPORATION, 401 HOLLAND LANE, #407, ALEXANDRIA, VA, 22314, US

(73) Assignee: FUJIFILM Corporation, Minato-ku (JP)

(21) Appl. No.: 11/919,223

(22) PCT Filed: May 18, 2006
(86) PCT No.: PCT/JP2006/310410

§ 371 Date: Oct. 25, 2007

(30) Foreign Application Priority Data
May 23, 2005 (JP) 2005-150188

(51) Int. Cl. G03B 17/00

(52) U.S. Cl. 396/55

(57) ABSTRACT

The present invention provides an image pickup device having: an image pickup component, a focal length computing component, a shutter speed computing component, a camera shake correction judging component, and a camera shake correcting component. The focal length computing component computes a focal length of an optical system. The shutter speed computing component computes a shutter speed of the image pickup component. At a time when the shutter speed computed by the shutter speed computing component is greater than a reciprocal of the focal length computed by the focal length computing component, the camera shake correction judging component judges that camera shake correction is to be carried out, and, at a time when the shutter speed is less than or equal to the reciprocal of the focal length, the camera shake correction judging component judges that camera shake correction is not to be carried out.

### TECHNICAL FIELD

The present invention relates to an image pickup device and a method of correcting camera shake thereof, and in particular, to an image pickup device and method of correcting camera shake thereof which aim to conserve electric power.

### BACKGROUND OF THE ART

If camera shake arises at the time of photographing a subject of photographing by a camera, the image quality deteriorates. Thus, various cameras which carry out camera shake correction are proposed.

For example, there has been disclosed a zoom camera having a high-magnification zoom function which prevents camera shake which arises easily at the time of long focal length photographing (see, for example, Japanese Patent Application Laid-Open (JP-A) No. 6-27514). In the zoom camera of JP-A No. 6-27514, a motor 1 for zooming drives a zooming lens 2, and a focal length detecting section 3 detects the current position at that time. A limit focal length computing section 4 computes the shutter speed from ISO information and brightness information of the subject of photographing, and computes a focal length limit value which will not cause camera shake at that shutter speed. When there is a shutter speed that will cause camera shake, a warning is given, and prohibiting processing corresponding to the focal length limit value, e.g., setting to a long focal point or the like, is carried out by a prohibiting section 5.

Further, there has been disclosed a camera in which, under specific photographing conditions such as high-magnification zoom photographing or the like in which the frequent occurrence of warning of camera shake is predicted, the annoyance due to frequent occurrence of warning of camera shake does not occur (see, for example, JP-A No. 2002-23243).

As shown in FIG. 1 of JP-A No. 2002-23243, the camera disclosed in JP-A No. 2002-23243 has: a photographing optical component 10 including a zoom lens 11; predicting components 15, 16b, 30 which predict the occurrence of camera shake from the relationship between a shutter speed ST and a focal length f of the zoom lens 11 set by the photographing optical component 10; and camera warning providing means 16c, 19, 26, 31 which provide a camera shake warning, in cases in which the occurrence of camera shake is predicted by the predicting components 15, 16b, 30 and provided that the shutter speed ST is less than or equal to a predetermined level.

In both JP-A No. 6-27514 and JP-A No. 2002-23243, the on/off state of the camera shake correcting function is set manually by the user. Therefore, there is the problem that a blurred image arises in cases in which the user forgets to set the camera shake correcting function to on regardless of the fact that there are conditions in which it is easy for camera shake to occur. Further, if the camera shake correcting function is always left on regardless of the fact that there are conditions in which it is difficult for camera shake to occur, the amount of electric power which is consumed increases, and there is the problem that the time over which image pickup is possible is shortened or the number of shots which can be picked-up decreases.

### DISCLOSURE OF THE INVENTION

The present invention is proposed in order to overcome the above-described drawbacks, and an object thereof is to provide an image pickup device and a camera shake correcting method thereof which automatically turn a camera shake correcting function on/off and suppress the amount of electric power which is consumed.

In order to overcome the above-described drawbacks, an image pickup device relating to the present invention has: an image pickup component picking-up a subject of photographing in accordance with pickup light which is incident via an optical system; a focal length computing component computing a focal length of the optical system; a shutter speed computing component computing a shutter speed of the image pickup component; a camera shake correction judging component which, at a time when the shutter speed computed by the shutter speed computing component is greater than a reciprocal of the focal length computed by the focal length computing component, judges that camera shake correction is to be carried out, and, at a time when the shutter speed is less than or equal to the reciprocal of the focal length, judges that camera shake correction is not to be carried out; and a camera shake correcting component which carries out camera shake correction when it is judged by the judging component that camera shake correction is to be carried out, and which does not carry out camera shake correction when it is judged by the judging component that camera shake correction is not to be carried out.

A method of correcting camera shake of an image pickup device relating to the present invention is a method of correcting camera shake of an image pickup device which picks-up a subject of photographing in accordance with pickup light which is incident via an optical system, the method having: computing a focal length of the optical system; computing a shutter speed of an image pickup component in accordance with an exposure value; at a time when the computed shutter speed is greater than a reciprocal of the computed focal length, judging that camera shake correction is to be carried out, and, at a time when the shutter speed is less than or equal to the reciprocal of the focal length, judging that camera shake correction is not to be carried out; and carrying out camera shake correction when it is judged that camera shake correction is to be carried out, and not carrying out camera shake correction when it is judged that camera shake correction is not to be carried out.

By comparing the shutter speed and the reciprocal of the focal length, it can be understood whether or not there is a state in which it is easy for camera shake to arise. In detail, if the shutter speed is greater than the reciprocal of the focal length, there is a state in which it is easy for camera shake to arise. If the shutter speed is less than or equal to the reciprocal of the focal length, there is a state in which it is difficult for camera shake to arise.

Thus, the present invention carries out camera shake correction when the shutter speed is greater than the reciprocal of the focal length, and does not carry out camera shake correction when the shutter speed is not greater than the reciprocal of the focal length. Therefore, the amount of electric power which is consumed can be greatly decreased as compared with a case in which the camera shake correcting function is always on.

The image pickup device and method of correcting camera shake thereof relating to the present invention judge that camera shake correction is to be carried out when the computed shutter speed is greater than the reciprocal of the computed focal length, and judge that camera shake correction is not to be carried out when the shutter speed is less than or equal to the reciprocal of the focal length. In this way, the amount of electric power which is consumed can be suppressed because camera shake correction is automatically carried out only in cases in which it is easy for camera shake to arise.

### BRIEF DESCRIPTION OF THE DRAWINGS

FIG. 1 is a block diagram showing the structure of an image pickup device relating to a first embodiment of the present invention.

FIG. 2 is a flowchart showing a camera shake correction routine.

FIG. 3 is a flowchart showing a camera shake correction routine of a second embodiment of the present invention.

FIG. 4 is a diagram showing a table of EV values.

### BEST MODE FOR CARRYING OUT THE INVENTION

Best modes for carrying out the present invention will be described in detail hereinafter with reference to the drawings.

### First Embodiment

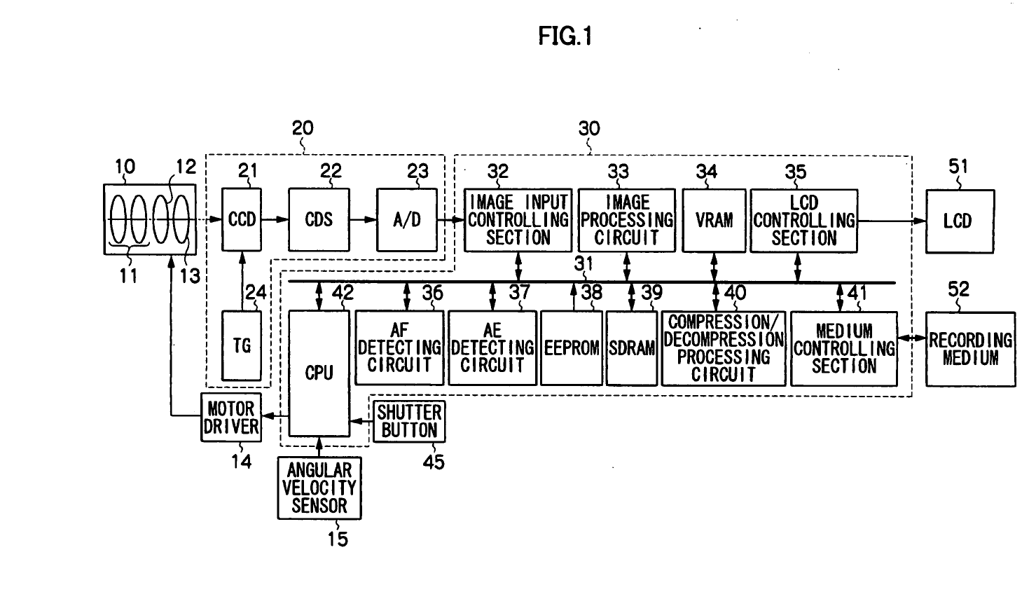

FIG. 1 is a block diagram showing the structure of an image pickup device relating to an embodiment of the present invention.

The image pickup device has an optical unit 10 to which pickup light from a subject of photographing is inputted; an image pickup section 20 disposed at the rear of the optical axis of the optical unit 10, and picking-up the subject of photographing via the optical unit 10; a main controlling section 30 carrying out image processing and overall control; and an output section outputting an image processed at the main controlling section 30.

The optical unit 10 has zoom lenses 11, a correction lens 12, a diaphragm mechanism, and a focus lens 13. The zoom lenses 11 can move in the optical axis direction by a zoom motor, and the focus lens 13 can move in the optical axis direction by an autofocus motor. The correction lens 12 is controlled by a correction lens motor such that the angle of incidence of the pickup light with respect to the image pickup surface is always substantially constant. The diaphragm of the diaphragm mechanism is controlled by an iris motor. These motors are controlled by a motor driver 14.

The image pickup section 20 has: a CCD image sensor 21 generating an image signal of the image of the subject of photographing in accordance with the pickup light from the optical unit 10; a CDS circuit 22 carrying out correlated double sampling (CDS) processing which removes noise components included in the image signal read-out from the CCD image sensor 21; an analog/digital converter (hereinafter called A/D converter) 23 which converts an analog signal, which was processed by the CDS circuit 22, into a digital signal; and a timing generator (TG) 24 generating a timing signal for driving the CCD image sensor 21.

The main controlling section 30 has various circuits which are connected to one another via a bus 31. In detail, the main controlling section 30 has: an image input controlling section 32 supplying the image data from the A/D converter 23 to the bus 31; an image processing circuit 33 carrying out predetermined digital signal processings on the inputted image data; a VRAM 34 for storing image data expressing an image to be displayed; and an LCD controlling section 35 carrying out control for displaying, on an LCD 51, an image which is based on the image data stored in the VRAM 34.

The main controlling section 30 also has: an AF detecting circuit 36 detecting a contrast value used for focal point adjustment of the focus lens 13; an AE (Auto Exposure) detecting circuit 37 detecting optimal exposure and white balance on the basis of image data; an EEPROM (Electrically Erasable Programmable Read Only Memory) 38 in which various types of programs and information such as parameters and the like are stored in advance; an SDRAM (Synchronous Dynamic Random Access Memory) 39 used as a work memory; a compressing/decompressing circuit 40 compressing and decompressing image data; a medium controlling section 41 which reads and writes various types of information from and to a recording medium 52; and a CPU 42 which reads-out appropriate information from the EEPROM 38 and controls the aforementioned respective sections.

The AF detecting circuit 36 detects the contrast value of the image data which is inputted from the image pickup section 20 and stored in the VRAM 34. Note that the focus position is obtained when this contrast value becomes a maximum.

The AE detecting circuit 37 detects the exposure value (EV value) expressing the brightness of the subject of photographing, on the basis of the image data. Although details will be described later, the EV value is used as a photometric value at the time of determining the diaphragm and shutter speed.

In the image pickup device which is structured as described above, the analog signal, which is outputted from the CCD image sensor 21 and which expresses the image of the subject of photographing, is subjected to processing by the CDS circuit 22, is converted into a digital image signal by the A/D converter 23, and thereafter, is inputted from the image input controlling section 32 into the main controlling section 30 as image data. This inputted image data is stored once in the SDRAM 39 via the bus 31.

At the main controlling section 30, on the basis of the image data stored in the SDRAM 39, the AF detecting circuit 36 computes the contrast value, and the AE detecting circuit 37 carries out AE computation. On the basis of these results of computation, the CPU 42 moves the focus lens 13 to the focus position via the motor driver 14, and sets the diaphragm mechanism and the electronic shutter function of the CCD image sensor 21 to appropriate exposure control values (diaphragm value and shutter speed), and sets an AWB adjustment value.

Note that, in the present embodiment, the AE detecting circuit 37 computes the EV value, which is the brightness of the subject of photographing, and the diaphragm value and the like on the basis of the image data. However, the present invention is not limited to the same. For example, an optical sensor, which detects the peripheral light amount, or the like may be provided, and computation carried out on the basis of the output of this optical sensor.

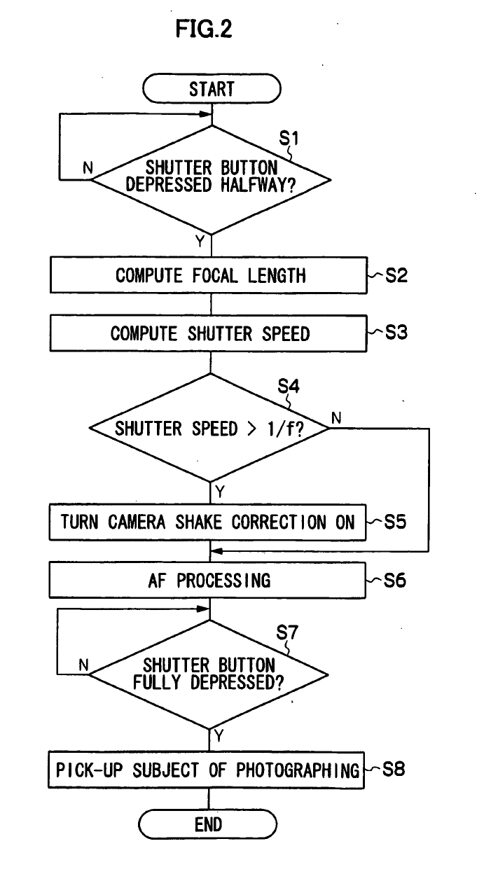

FIG. 2 is a flowchart showing a camera shake correcting routine. Namely, the CPU 42 executes the processings of following step S1 and steps thereafter. Note that it is assumed that camera shake correction processing has not been carried out before the present routine is executed.

In step S1, after the angle of view is determined by the zoom lenses 11, the CPU 42 judges whether or not a shutter button 45 has been depressed halfway, and the routine stands-by until the shutter button 45 is depressed halfway. When the CPU 42 detects that the shutter button 45 is depressed halfway, the routine moves on to step S2.

In step S2, the CPU 42 reads-in the positions (zoom positions) of the zoom lenses 11 obtained by encoders, and computes a focal length f on the basis of the zoom positions, and the routine moves on to step S3.

In step S3, at the AE detecting circuit 37, the exposure value is computed on the basis of the photometric value (EV value) and the ISO sensitivity which is set in advance. By using these information, the CPU 42 refers to a program chart of the image pickup device, computes the diaphragm value and the shutter speed (the shutter opening time [s]), and the routine moves on to step S4.

In step S4, the CPU 42 judges whether

shutter speed>l/(focal length f)

is established. If this judgment is affirmative, the routine proceeds to step S5, whereas if this judgment is negative, the routine proceeds to step S6.

In step S5, the CPU 42 turns the camera shake correction on. In detail, on the basis of a vibration frequency detected at an angular velocity sensor 15, the CPU 42 successively adjusts, via the motor driver 14, the angle of the correction lens 12 with respect to the image pickup surface of the CCD image sensor 21, and controls the angle of incidence of the pickup light with respect to the image pickup surface to be always be substantially constant. The routine then moves on to step S6.

In step S6, the CPU 42 executes autofocus processing. In detail, while the CPU 42 moves the focus lens 13 via the motor driver 14, the CPU 42 detects the position at which the contrast detected at the AF detecting circuit 36 becomes a maximum, and sets the focus lens 13 to this position. The routine then proceeds to step S7.

In step S7, the CPU 42 judges whether or not the shutter button 45 is fully depressed, and the routine stands-by until the shutter button 45 is fully depressed. When the CPU 42 detects that the shutter button 45 is fully depressed, the routine moves on to step S8.

In step S8, the CPU 42 controls the CCD image sensor 21 to pick-up the subject of photographing at the shutter speed computed in step S3. In this way, the image of the subject of photographing generated at the CCD image sensor 21 is converted into a digital signal, is compressed at the compressing/decompressing circuit 40, and thereafter, is recorded on the recording medium 52 via the medium controlling section 41 or is displayed on the LCD 51 via the LCD controlling section 35.

As described above, the image pickup device relating to the first embodiment computes the focal length f and the shutter speed, and, when “shutter speed>(l/focal length f)” is established, carries out camera shake correction, and thereafter picks-up the subject of photographing. In this way, the image pickup device turns the camera shake correcting function on automatically only when camera shake arises. Therefore, the amount of electric power which is consumed can be suppressed as compared with a case in which the camera shake correcting function is always on.

### Second Embodiment

A second embodiment of the present invention will be described next. Similar reference numerals are applied to circuits which are similar to those of the first embodiment, and detailed description thereof is omitted. An image pickup device relating to the second embodiment is structured as shown in FIG. 1, and executes the following camera shake correcting routine.

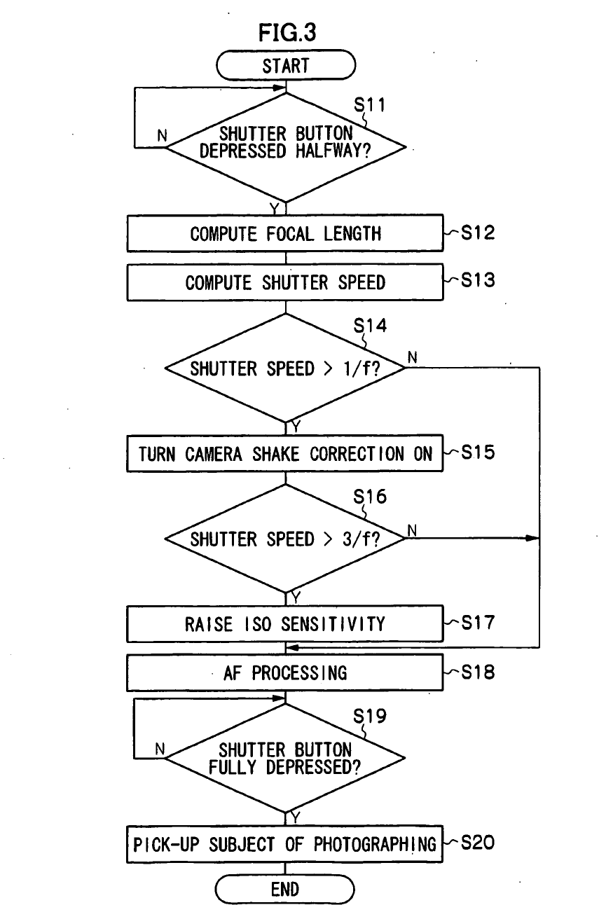

FIG. 3 is a flowchart showing a camera shake correcting routine of the second embodiment. Namely, the CPU 42 executes the processings of following step S11 and steps thereafter. Note that it is assumed that camera shake correction processing has not been carried out before the present routine is executed.

Step S11 to step S15 of the present routine are the same as step S1 to step S5 of the camera shake correcting routine shown in FIG. 2. Thus, steps from step S16 of FIG. 3 will be described.

In step S16, the CPU 42 judges whether

shutter speed>n/(focal length f)

is established. If this judgment is affirmative, the routine proceeds to step S17, whereas if this judgment is negative, the routine proceeds to step S18. Note that n is a natural number of three or more.

Times when the above relation is established are times when the shutter speed is long because the brightness of the subject of photographing is insufficient. Thus, the CPU 42 carries out the following processing.

In step S17, the CPU 42 carries out setting such that the ISO sensitivity rises.

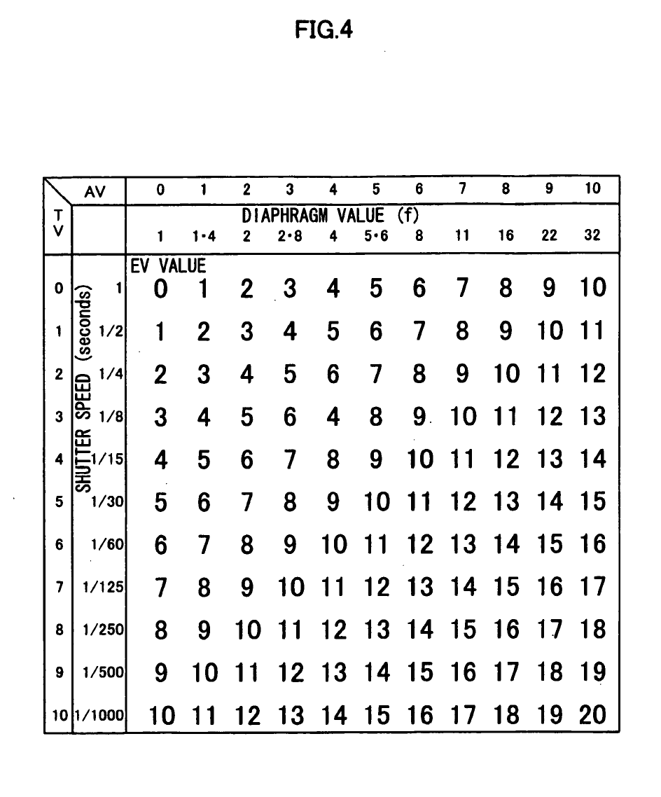

FIG. 4 is a diagram showing a table of EV values. As shown in FIG. 4,

EV=AV+TV=SV+BV

is established. AV (Aperture Value) is a numerical value expressing the diaphragm. TV (Time Value) is a numerical value expressing the shutter speed. SV (Speed Value) is a numerical value expressing the ISO sensitivity. BV (Brightness Value) is a numerical value expressing the absolute value of the brightness of the subject of photographing. In accordance with the above formula, if the ISO sensitivity SV is made to be one level higher, the shutter speed TV can be made to be one level faster in accordance therewith.

Thus, the CPU 42 carries out setting such that, for example, the shutter speed is made to be one level or more faster, or carries out setting such that the diaphragm is opened one level or more, and the routine moves on to step S18. Note that the CPU 42 may simultaneously set the shutter speed and the diaphragm such that the EV value becomes large.

From steps S18 to S20, the CPU 42 carries out processings similar to those of from steps S6 to S8 shown in FIG. 2.

As described above, the image pickup device relating to the second embodiment computes the focal length f and the shutter speed, and when “shutter speed>n/(focal length f)” is established, carries out setting which raises the ISO sensitivity, and thereafter, picks-up the subject of photographing. In this way, when the light amount of the subject of photographing is insufficient, the image pickup device can raise the ISO sensitivity and pick-up a good image. Further, in the same way as in the first embodiment, the above-described image pickup device automatically carries out camera shake correction when “shutter speed>l/(focal length f)” is established, and thereafter picks-up the subject of photographing. Therefore, the above-described image pickup device can suppress the amount of electric power which is consumed.

In the first and second embodiments, the image pickup device may be structured so as to be able to adjust the camera shake correction amount in a stepwise manner. Further, the image pickup device may change the camera shake correction pattern in accordance with the focal length. For example, as the focal length becomes f1, f2, f3 (f1<f2<f3), the image pickup device may make the camera shake correction amount be a, b, c (0<a<b<c≦100)[%].

Note that the present invention is not limited to the above-described embodiments, and can also be applied to structures whose designs are modified within the scope of the claims. For example, the image pickup device of the present invention is not limited to the structure illustrated in FIG. 1.

Further, the image pickup device of each of the above-described embodiments carries out camera shake correction by moving the correction lens 12 and successively correcting the optical axis of the pickup light incident on the CCD image sensor 21. However, the camera shake correction is not limited to this processing. For example, the image pickup device may correct the optical axis of the pickup light incident on the CCD image sensor 21 by moving a prism within the optical unit 10, or the CCD image sensor 21. Namely, the present invention can be applied to any structure provided that it is a camera shake correcting function.

1. An image pickup device comprising:
an image pickup component picking-up a subject of photographing in accordance with pickup light which is incident via an optical system;
a focal length computing component computing a focal length of the optical system;
a shutter speed computing component computing a shutter speed of the image pickup component;
a camera shake correction judging component which, at a time when the shutter speed computed by the shutter speed computing component is greater than a reciprocal of the focal length computed by the focal length computing component, judges that camera shake correction is to be carried out, and, at a time when the shutter speed is less than or equal to the reciprocal of the focal length, judges that camera shake correction is not to be carried out; and
a camera shake correcting component which carries out camera shake correction when it is judged by the judging component that camera shake correction is to be carried out, and which does not carry out camera shake correction when it is judged by the judging component that camera shake correction is not to be carried out.

2. The image pickup device of claim 1, further comprising a sensitivity setting component which, when it is judged by the camera shake correction judging component that camera shake correction is to be carried out, judges whether the shutter speed is greater than a natural number multiple of three or more of the reciprocal of the focal length, and carries out setting so as to raise sensitivity when the shutter speed is greater than a natural number multiple of three or more of the reciprocal of the focal length, and does not carry out setting which raises the sensitivity when the shutter speed is not greater than a natural number multiple of three or more of the reciprocal of the focal length.

3. A method of correcting camera shake of an image pickup device which picks-up a subject of photographing in accordance with pickup light which is incident via an optical system, the method comprising:
computing a focal length of the optical system;
computing a shutter speed of an image pickup component in accordance with an exposure value;
at a time when the computed shutter speed is greater than a reciprocal of the computed focal length, judging that camera shake correction is to be carried out, and, at a time when the shutter speed is less than or equal to the reciprocal of the focal length, judging that camera shake correction is not to be carried out; and
carrying out camera shake correction when it is judged that camera shake correction is to be carried out, and not carrying out camera shake correction when it is judged that camera shake correction is not to be carried out.

4. The method of correcting camera shake of claim 3, wherein, when it is judged that camera shake correction is to be carried out, it is judged whether the shutter speed is greater than a natural number multiple of three or more of the reciprocal of the focal length, and when the shutter speed is greater than a natural number multiple of three or more of the reciprocal of the focal length, setting is carried out so as to raise sensitivity, and when the shutter speed is not greater than a natural number multiple of three or more of the reciprocal of the focal length, setting which raises the sensitivity is not carried out.
